(19) United States
(12) Patent Application Publication
(10) Pub. No.: US 2005/0179261 A1
(43) Pub. Date: Aug. 18, 2005

(54) Device for cooling a current generator unit

(76) Inventors: Ernst Hatz, Ruhstorf/Rott (DE); Franz Moser, Schardenberg (AT)

Correspondence Address: KATTEN MUCHIN ROSENMAN LLP, 575 MADISON AVENUE, NEW YORK, NY, 10022-2585, US

(21) Appl. No.: 10/515,986

(22) PCT Filed: Jun. 25, 2003
(86) PCT No.: PCT/EP03/06656

(30) Foreign Application Priority Data
Jun. 25, 2002 (DE) 10228224.2

(51) Int. Cl. H02K 5/00

(52) U.S. Cl. 290/1 A

(57) ABSTRACT

The invention relates to a current generator unit consisting of a generator and reciprocating engine as the drive system, in particular consisting of a synchronous generator and a diesel engine and comprising a cooling device for the common cooling of the generator and reciprocating engine. Said unit comprises a fan wheel (2) that axially aspirates the cooling air (L) on the motor side and evacuates the latter radially and that has a first passage (49) located in the radial exterior zone of the blades (4) and a second passage (50) located radially inside the blades (4). A small portion (S2) of the cooling air (L) (“generator cooling air”) is fed exclusively to the generator on the motor side via the first passage (49) and is evacuated via the second passage (50) and a predominant portion (S1) of the cooling air (L) (“motor cooling air”) is fed to the reciprocating engine.

The present invention relates to a device for the common cooling of the generator and the driving reciprocating engine of a current generator unit.

Such cooling devices are known. For example, EP 1 054 144 A2 describes a motor/generator unit in which a main fan wheel is arranged for the common cooling of the generator and the engine, which wheel is turned together with the rotor of the generator, which is driven by the engine. By means of turning the main fan wheel, fresh cooling air is drawn in by way of openings arranged over the generator housing, in the form of holes and slits, and passed to a generator cooling segment to cool the generator, and to an engine cooling segment to cool the engine. In addition to the main fan wheel, an additional ancillary fan wheel is provided, by means of which cooling air that particularly serves to cool the stator and the coils is drawn into the generator, by way of additional openings in the generator housing. The cooling air drawn in by way of the ancillary fan wheel is mixed with the cooling air drawn in by the main fan wheel, and passed to the engine in order to cool it.

Furthermore, DE 100 10 248 A1 of the current applicant describes such a cooling device for a current generator as a unit consisting of a drive engine and a generator. In this device, a fan wheel serves for the common cooling of the drive engine and the generator. The fan wheel is turned by the crankshaft of the drive engine, thereby drawing fresh cooling air in through openings in the generator housing provided for this purpose. The cooling air passes through the generator interior, to cool the generator, and is subsequently passed to the drive engine, to cool the latter.

Although satisfactory cooling performance can be achieved with the cooling devices known from the state of the art, it has proven to be disadvantageous that in order to draw in the fresh air via the generator housing, the latter must be equipped with correspondingly large passage openings for the cooling air. This is all the more true if, as is usual, the entire cooling air for the generator and the drive engine is drawn in via the generator housing, because a cooling performance that is greater by a factor of 10 to 20 must be provided at the drive engine, in comparison with the generator.

If the current generator unit is supposed to be closed off towards the outside, to a great extent, for example in order to achieve the high degree of protection of electrical devices standardized in accordance with DIN 40050, this is only possible with certain restrictions, because of the large air passage openings. Until now, technically complicated and cost-intensive arrangements have had to be made for this purpose. For example the generator can be accommodated in a mechanically strong, water-tight and dust-tight protective covering, in addition to its actual generator housing. To cool the generator, the cooling medium flows around the protective covering from the outside, and this presumes that sufficient heat transport from the generator to the protective covering is assured. In addition, an appropriately secured cable guide for the generator must be additionally provided. Aside from the technical difficulties and the high costs connected with this, such a solution requires sufficient space for assembly, something that represents an insurmountable obstacle in many cases, if only for this reason.

It is the task of the present invention to overcome the disadvantages of the devices for the common cooling of the generator and the reciprocating engine that are known from the state of the art. According to one suggestion of the invention, this task is accomplished by means of the characteristics of the independent claim. Advantageous embodiments of the invention result from the characteristics of the dependent claims.

According to the invention, a current generator unit consisting of a generator and reciprocating engine as the drive system, in particular consisting of a synchronous generator and a diesel engine and comprising a cooling device for the common cooling of the generator and reciprocating engine is proposed, in which, by means of a fan wheel that axially aspirates the cooling air and evacuates it radially, which has at least a first passage located in the radial exterior zone of the blades and at least a second passage located radially inside the blades, a small portion of the cooling air (“generator cooling air”) is fed exclusively to the generator on the motor side via the first, outer passage and is evacuated via the second, inner passage, while a predominant portion of the cooling air (“motor cooling air”) is fed to the reciprocating engine by the fan wheel.

Since the second, inner passage is arranged on the segment of the fan wheel that draws in the cooling air (the fan wheel essentially aspirates the cooling air in its axial center), the generator cooling air is drawn in there, by means of the local suction effect. Overall, a generator cooling air stream forms in the generator, in which the generator cooling air that flows radially out of the fan wheel is passed to the generator by means of the first, outer passage, and is passed out of the generator chamber again by means of the second, inner passage of the fan wheel. The generator cooling air that flows through the second, inner passage of the fan wheel subsequently mixes with the fresh cooling air aspirated by the fan wheel, whereby the cooling air that has now been slightly heated is passed for the minor part to the generator and for the major part to the drive engine.

The first, outer passage for entry of the generator cooling air into the generator is preferably present in the form of a circular slit. The slit can have an opening width of 2-5 mm, particularly approximately 3 mm. The generator cooling air that enters into the generator through the circular slit is aspirated out of the generator chamber again by way of the second, inner passage of the fan wheel. The second, inner passage is preferably present in the form of circular perforations of the fan wheel. These perforations, for example 5 to 7 in number, preferably have a diameter in the range of 20 to 50 mm, particularly 30 mm. It is important in this connection that mechanical weakening of the fan wheel is always connected with drilling the perforations, so that the fan wheel should only have a certain number of passage holes, depending on the size of the mechanical forces that occur, since otherwise, an increase in the wall thickness of the fan wheel is necessary in this region.

In contrast to the known cooling devices, there is no attempt to use all of the cooling air that is aspirated by the fan wheel to cool the generator—instead, only a small portion of the aspirated cooling air, sufficient to cool the generator, which requires a lower cooling output, is branched off into the generator chamber.

Because of the generally significantly greater waste heat of the drive engine, the cooling air partly heated by the generator can be used to subsequently cool the drive engine. The generator of the current generator unit according to the invention preferably has a degree of effectiveness of at least 90%, in contrast to the generators known from the state of the art, which generally have a degree of effectiveness only in the range of 75-85%. The cooling air already partly heated by the generator is also always mixed with cooling air freshly aspirated by the fan wheel, in order to cool the engine, so that a sufficient removal of waste heat of the drive engine is guaranteed, in any case.

The diameters of the first, outer passage and the second, inner passage must be sized in accordance with the cooling performance that is required. A greater waste heat of the generator requires a larger amount of generator cooling air supplied, and vice versa.

In order to guarantee that the generator cooling air enters into the generator and exits from it again at approximately the same flow velocity, it is preferred if the cross-sectional area of the first passage and the cross-sectional area of the second passage are approximately the same.

In a particularly advantageous manner, the current generator unit according to the invention does not have to have any air entry openings in the generator housing, and therefore can be implemented to be sealed on the generator side, particularly to be water-tight and dust-tight. In contrast to the measures for a dust seal and a water seal that are known in the state of the art, this protection can be achieved in space-saving manner, without technically complicated means, and very inexpensively. In this connection, it is preferred if the generator has a degree of protection for contact protection and foreign body protection according to DIN 40050 (first index) of at least the number 6. Furthermore, it is preferred if the generator has a degree of protection for water protection according to DIN 40050 (second index) of at least the number 4. With regard to mechanical stress, it is preferred if the generator generator housing has a degree of protection according to DIN 40050 (third index) of at least the number 3. In this connection, however, it must be noted that the ability of the generator housing to withstand mechanical stress is significantly dependent on the choice of material, and therefore is at the discretion of a person skilled in the art, to a great extent.

A particularly advantageous embodiment of the device according to the invention provides that at least 5% and at most 10% of the cooling air that leaves the fan wheel is passed to the generator as generator cooling air, in accordance with the generally far lower cooling requirement, as compared with the drive engine.

In advantageous manner, the generator cooling air is deflected before entering into the generator, which has the result that solid and liquid contaminants drawn in with the cooling air are deposited on the walls of the cooling air guide, because of their mass inertia, before the generator cooling air enters into the generator. In this way, cleaning of the cooling air can be effected in simple manner; this would otherwise have to take place by means of technically complicated and expensive measures, such as filter systems and the like.

The invention will now be explained in greater detail, using an exemplary embodiment, making reference to the attached drawing.

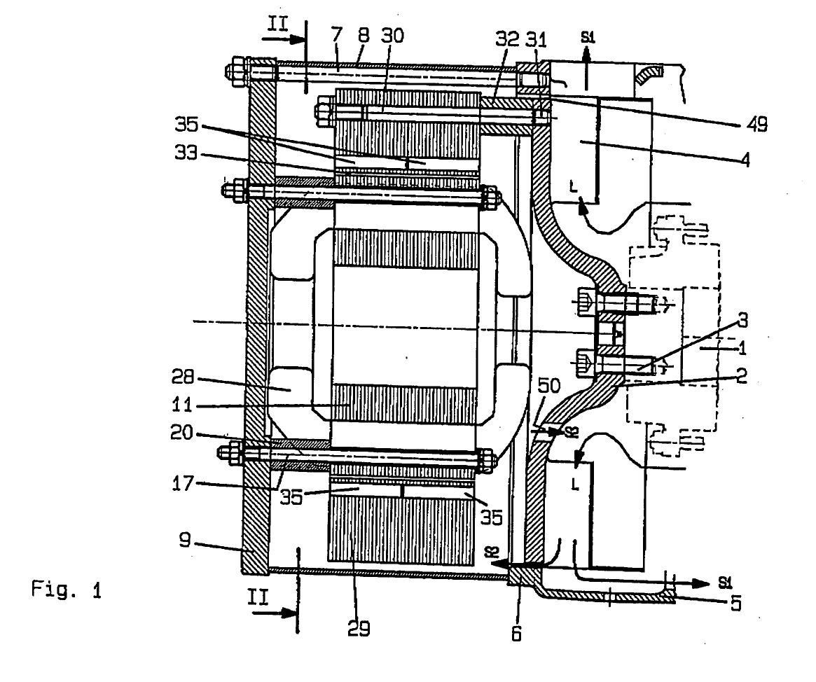

FIG. 1 shows an axial cross-section through an engine/generator unit.

The electrical machine forming a current generator, shown in FIG. 1, relates to a unit made up of a drive engine and a synchronous generator. Preferably, a diesel engine is used as the drive engine; only the connector-side end of its crankshaft 1 is shown, with a broken line.

A fan wheel 2 is built onto the face of the crankshaft 1, by means of screws 3. The fan wheel 2 possesses blades 4, by means of which the cooling air is drawn in, in accordance with arrow L, on the engine side, in the axial direction, to generate air streams in accordance with arrow S1 for engine cooling, and in accordance with arrow S2 for generator cooling, and flows out again in the radial direction. The cooling air stream S2 is passed into the generator chamber through a first outer passage 49 in the form of a ring-shaped slit shown in FIG. 1 (see arrow S2, directed to the left, in FIG. 1). The cooling air S2 that is passed into the generator chamber is drawn out of the generator chamber by way of the passage holes 50 (see arrow S2, directed to the right, in FIG. 1) arranged inside the blades 4 of the fan wheel 2, by means of the suction effect of the fan wheel 2 that prevails there.

Within the generator chamber, several cooling air streams can form, depending on the flow resistances of the possible flow paths. In the exemplary embodiment shown, essentially two different cooling air streams are formed, a short flow path between the slit 49 and the passage holes 50, in which the stator winding on the motor-side winding head is cooled, as well as a longer flow path, in which the general cooling air cools the stator winding 28 in its entire spatial expansion. Because of the good heat conductivity of the winding material used, the relative amount ratio of the different generator cooling air streams in the generator chamber plays a subordinate role.

In the exemplary embodiment shown, the entry direction of the generator cooling air into the generator chamber is approximately perpendicular to the radial direction of the fan wheel 2. This guarantees that solid and liquid contaminants that are transported with the cooling air are separated from the generator cooling air stream because of their mass inertia.

The opening width of the slit 49 is approximately 3 mm. Six passage openings 50 having a diameter of approximately 30 mm are drilled in the fan wheel 2. The cross-sectional area of the slit 49 is selected in such a manner that it is approximately equal to the sum of the cross-sectional areas of the six passage openings 50, thereby assuring a uniform inflow and outflow of generator cooling air.

The proportion of the generator cooling air stream branched into the generator chamber can be regulated by way of the opening width of the slit 49. Because of the very good degree of effectiveness of the generator shown in the exemplary embodiment, which generally lies above 90%, it is sufficient if approximately 5-10% of the cooling air L drawn in by the fan wheel 2 is passed to the generator as generator cooling air, by the fan wheel.

A connector housing 5 on the engine side encloses the space in which the fan wheel 2 is accommodated, radially towards the outside; it is open towards the engine and, on the opposite side, possesses a ring flange 6 having threaded bores for screwing in attachment screws 7 for connecting the cylindrical generator housing 8, whereby the latter is clamped in over a flat area, on both faces. The attachment screws 7 are usually arranged distributed over the circumference on the inside of the generator housing 8, and pass through the entire length of the housing. On the left end of the generator housing 8 in the drawing, a generator housing lid 9 is provided, to which the stator 11 of the generator is attached. The shafts of the attachment screws 7 project through bores in the generator housing lid 9.

While eight attachment screws 7 distributed over the circumference are provided according to the present exemplary embodiment, six stator screws 17 are sufficient to attach the stator; these are passed through bores in the sheet-metal package of the stator 11 and are screwed in by way of spacer sleeves 20. The stator 11 accommodates the winding strands of the rotary current winding 28 of the generator.

The stator 11 is surrounded by the rotor 29, which is also structured of a sheet-metal package, and is held together by means of straining screws 30, which are screwed into corresponding threaded bores of the fan wheel 2 with a threaded end 31 on the engine side. Between the fan wheel and the related side of the rotor 29, support sleeves 32 pushed onto the straining screws 30 are held in place. In this manner, the rotor 29 is connected with the fan wheel 2 so as to rotate with it. On its inside circumference, it forms a narrow air gap 33, having a width of approximately 2 mm, relative to the stator 11. In addition, the rotor 29 possess pockets that are continuous in the axial direction, which run approximately circular within two segments, into which magnet elements 35 are inserted from both sides, which are responsible for the magnetic excitation of the generator.

1. Current generator unit consisting of a generator and reciprocating engine as the drive system, in particular consisting of a synchronous generator and a diesel engine and comprising a cooling device for the common cooling of the generator and reciprocating engine, comprising a fan wheel (2) that axially aspirates the cooling air (L) on the motor side and evacuates the latter radially, which has a first passage (49) located in the radial exterior zone of the blades (4) and a second passage (50) located radially inside the blades (4), wherein a small portion (S2) of the cooling air (L) (“generator cooling air”) is fed exclusively to the generator on the motor side via the first passage (49) and is evacuated via the second passage (50), and wherein a predominant portion (S1) of the cooling air (L) (“motor cooling air”) is fed to the reciprocating engine.

2. Current generator unit as recited in claim 1,
characterized in that
the outer passage (49) is a circular slit.

3. Current generator unit as recited in claim 2,
characterized in that
the circular slit has an opening width in the range of 2 to 5 mm, particularly 3 mm.

4. Current generator unit as recited in claim 1,
characterized in that
the inner passage (50) is present in the form of circular perforations of the fan wheel.

5. Current generator unit as recited in claim 4,
characterized in that
a circular perforation has a diameter in the range of 20 to 50 mm, particularly 30 mm.

6. Current generator unit as recited in claim 1,
characterized in that
the cross-sectional area of the outer passage (49) and the cross-sectional area of the inner passage (50) is essentially the same.

7. Method as recited in claim 1,
characterized in that
the generator cooling air (S2) comprises at least 5% and at most 10% of the entire cooling air (L).

8. Method as recited in claim 1,
characterized in that
the flow direction of the generator cooling air (S2) is deflected before entering into the generator.

9. Method as recited in claim 8,
characterized in that
the flow direction of the generator cooling air is deflected at an angle of approximately 90°.

10. Current generator unit as recited in claim 1,
characterized in that
the generator has a degree of protection for contact protection and foreign body protection according to DIN 40050 (first index) of at least the number 6.

11. Current generator unit as recited in claim 1,
characterized in that
the generator has a degree of protection for water protection according to DIN 40050 (second index) of at least the number 4.

12. Current generator unit as recited in claim 1,
characterized in that
the generator has a degree of protection for mechanical stress according to DIN 40050 (third index) of at least the number 3.

13. Current generator unit as recited in claim 1,
characterized in that
the generator has a degree of effectiveness of at least 90%.
